(19) United States
(12) Patent Application Publication
(10) Pub. No.: US 2009/0036004 A1
(43) Pub. Date: Feb. 5, 2009

(54) Receptacle terminal

(75) Inventors: Michael David Bowen, Suffolk (GB); Suhaimi Bin Mohd Sepet, Singapore (SG)

Correspondence Address: RADER FISHMAN & GRAUER PLLC, LION BUILDING, 1233 20TH STREET N.W., SUITE 501, WASHINGTON, DC, 20036, US

(73) Assignees: J.S.T. (U.K) Ltd., Suffolk (GB); MEA Technologies Pte. Ltd., Singapore (SG)

(21) Appl. No.: 12/219,492

(22) Filed: Jul. 23, 2008

(30) Foreign Application Priority Data
Jul. 31, 2007 (SG) 200705547-8

(51) Int. Cl. H01R 13/11

(52) U.S. Cl. 439/849

(57) ABSTRACT

A receptacle terminal includes a cable connection portion 31 connected to a cable, and a contacting portion 2 insertion-connected to a tab terminal. The contacting portion 2 has a flat part 21 of a particular area, and a pair of sideplate parts 23, 23 of a particular length that stand up in the same direction from the two sides of the flat part and oppose each other at a particular spacing. The lower portion of the opposed surfaces of such pair of sideplate parts 23, 23 is cut and lifted out to form spring pieces 24, 24 which remains joined to the sideplate at the top. Such spring pieces are bent toward each other, forming a gap between the bottom edge of each spring piece and the flat part, and the tab terminal 4 is inserted into such gaps. A simple structure and strong elastic contacting force are provided.

### TECHNICAL FIELD

The present invention relates to a receptacle terminal, and more particularly to a receptacle terminal that is optimal for coupling with a tab terminal having a plate-form male contact with an elongated contacting portion.

### BACKGROUND ART

Receptacle terminals of this kind are formed by punching and bend-processing metal plate. Such terminals are normally housed in an insulative terminal housing when used. Examples of such receptacle terminals are disclosed in U.S. Pat. No. 5,800,220 and U.S. Pat. No. 4,423,921.

As FIG. 5 shows, a receptacle terminal 50 disclosed in U.S. Pat. No. 5,800,220 has a cable connection portion 51 that is crimp-connected to a cable, and a contacting portion 52 that is contact-connected to a tab terminal. The front end of the contacting portion 52 is formed as a flattened tubular body 53 with a rectanguloid opening. This flattened tubular body 53 has relatively broad flat portions 53a, 53b on its top and bottom surfaces. A part of each flat portion is cut out, and such parts are flexed toward each other. Such flexed portions are resilient, and their resilience is utilized to effect crimp-connection with the tab terminal.

The receptacle terminal disclosed in U.S. Pat. No. 4,423,921 also has a cable connection portion that is crimp-connected to a cable, and a contacting portion that is contact-connected to a tab terminal. The contacting portion 52 is formed with a flat plate-form base, a pair of sideplate parts that rise up from the two sides of the base, and a resilient latching piece that is cut out of the base so as to project downward therefrom. Each sideplate part is flexed, part-way from the edge, toward the opposing sideplate part, thus forming a flange. It is these flange portions that are crimp-connected to the tab terminal.

The receptacle terminals disclosed in U.S. Pat. No. 5,800,220 and U.S. Pat. No. 4,423,921 are both formed by punching and bend-processing metal plate. However, in the receptacle terminal disclosed in U.S. Pat. No. 5,800,220, because the contacting portion which connects to the tab terminal is formed as a flattened tubular body with a rectanguloid opening at the front end, a metal plate with a wide area is needed in order to manufacture such tubular body, and moreover the punching and bend-processing thereof is troublesome.

By contrast, the contacting portion of the receptacle terminal disclosed in U.S. Pat. No. 4,423,921 has a flat plate-form base portion and a pair of sideplate parts that rise up from the two sides of the base portion and that part-way are bent toward each other to form a pair of flanges, crimp-connection to the tab terminal being effected by means of these flanges; because of which, the size of the metal plate can be small compared with the receptacle terminal having a flattened tubular body disclosed in U.S. Pat. No. 5,800,220. Yet, because the receptacle terminal with such structure has its contacting portion formed with the pair of sideplate parts bent part-way, its elastic contacting force when connected to the tab terminal is weak compared with that of the flattened tubular body item.

### SUMMARY

An advantage of some aspects of the present invention is to provide a receptacle terminal with a simple structure and strong elastic contacting force.

Another advantage of some aspects of the invention is to provide a receptacle terminal that can be manufactured in a simple manner using metal plate of small area compared with the related art.

According to an aspect of the invention, a receptacle terminal includes a cable connection portion that is connected to a cable, and a contacting portion that is insertion-connected to a tab terminal. The contacting portion has a plate-form flat part of a particular area, and a pair of sideplate parts of a particular length that stand up in the same direction from the two sides of the flat part and oppose each other at a particular spacing. Part of the lower portion of the opposed surfaces of such pair of sideplate parts is cut and lifted out to form a spring piece, which remains joined to the sideplate at the top. Such spring pieces are bent toward each other, forming a gap between the bottom edge of each spring piece and the flat part, and the tab terminal is inserted into such gaps.

With the above features, the spring pieces of the contacting portion are formed by cutting and lifting a part of the sideplate parts, and therefore the contacting portion requires little material to form, and moreover can be manufactured in a simple manner and at reduced cost.

In the aspect, one or plural spring pieces may be provided on each sideplate part.

With the above features, provision of one or plural spring pieces on each sideplate part enables the spring piece elastic force to be varied according to the number of spring pieces, so that a good connection will be possible at insertion-connection to the tab terminal.

In the aspect, the spring pieces may be formed in a rectangular shape.

With the above features, forming the spring pieces in a rectangular shape will enable the area of contact with the tab terminal to be rendered large.

In the aspect, the spring pieces may be formed as resilient pieces that can be flexed, and the gaps may be made smaller than the thickness of the tab terminal.

With the above features, forming the spring pieces as resilient pieces that can be flexed and making the gaps smaller than the thickness of the tab terminal will enable to hold the tab terminal between the flat portion and the spring pieces, thereby improving the connection with the tab terminal.

In the aspect, a resilient lever may be formed in the flat part by cutting out and flexing upward a part thereof.

In the aspect, there may be formed in the resilient lever a small boss that projects upward from the surface thereof.

With the above features, during insertion-connection to the tab terminal, the tab terminal will be pushed up by the resilient lever, thus increasing the contacting pressure, and moreover the small boss in the resilient lever will fit into a concavity in the tab terminal, enabling firm connection.

In the aspect, the contacting portion and the cable connection portion may be formed by punching and bend-processing of metal plate with good conductivity.

With the above features, manufacture can be effected in a simple manner and at reduced cost, by using metal plate raw material of smaller area than with the related art.

### BRIEF DESCRIPTION OF DRAWINGS

The invention will be described with reference to the accompanying drawings, wherein like numbers reference like elements.

FIG. 1 is an external perspective view of a receptacle terminal in an embodiment of the invention.

FIG. 2 explicates the connection of the receptacle terminal and a tab terminal, FIG. 2A being a side view of the state where part of the tab terminal has been inserted into the receptacle terminal, FIG. 2B being an enlarged view of portion IIB in FIG. 2A, and FIG. 2C being a top view of the state in FIG. 2A.

FIG. 3 is a perspective view of the state where the tab terminal has been inserted into the receptacle terminal.

FIG. 4 is a cross-sectional view along line IV-IV in FIG. 3.

FIG. 5 is an external perspective view illustrating a receptacle terminal of the related art.

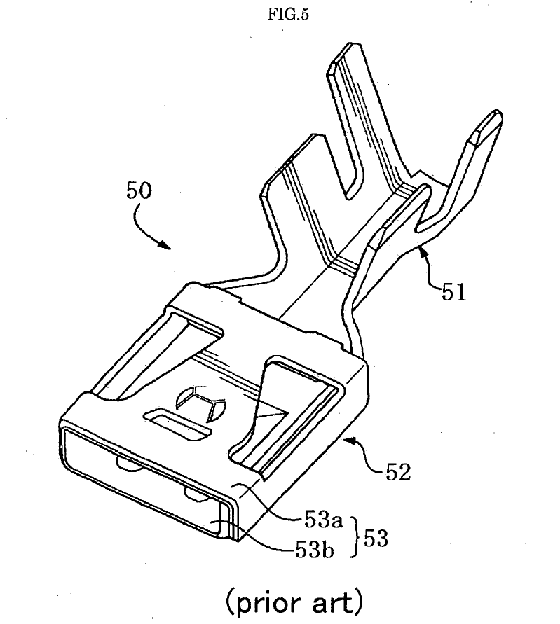

### DESCRIPTION OF EXEMPLARY EMBODIMENT

An exemplary embodiment of the present invention will now be described with reference to the accompanying drawings. It should be understood however that the following embodiment is given by way of an example of a receptacle terminal that realizes the technical concepts of the invention, and is not intended to limit the invention to this particular receptacle terminal. The invention can equally well be adapted to other embodiments within the scope and spirit of the claims.

### First Embodiment

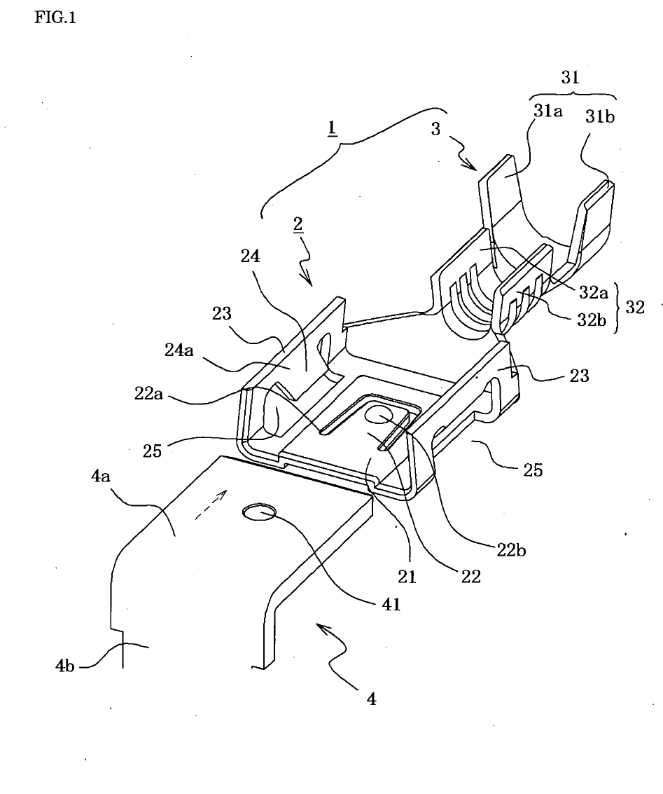

FIG. 1 is a perspective view of a receptacle terminal of an embodiment of the present invention. This receptacle terminal 1 has a cable connection portion 3 that is crimp-connected to a cable, and a contacting portion 2 that is contact-connected to a tab terminal 4. The cable connection portion 3 includes a cable fixing part 31 that fixes the cable sheathing, and a core connection part 32 that contacts with and is fixed to the cable core. The cable fixing part 31 has a pair of tabs 31a, 31b, and the cable is fixed by bending and crimping these tabs 31a, 31b. The core connection part 32 has a pair of tabs 32a, 32b, and is connected and fixed to the cable core by bending and crimping these tabs 32a, 32b. Further, the bottom has concavities and convexities formed therein. These concavities and convexities are provided to dig into the core during crimp-connection and thereby improve connection to the core.

The contacting portion 2 has a flat part 21 of a flat plate form having a particular area, and a pair of sideplate parts 23, 23 of a particular length that are bent up from the two longitudinal sides of the flat part 21 so as to rise up at perpendicularly. The flat part 21 is approximately rectangular in shape, having a width approximately the same as the width of the tab terminal 4, and a particular length such as to contact with the tab terminal 4. Also the flat part 21 has, roughly in the center, a cut-and-lifted piece 22 formed by cutting and lifting a portion thereof. One end of this cut-and-lifted piece 22 is joined to the flat part 21, but the periphery thereof except such joined portion is separated off by a slot 22a. Thus, the cut-and-lifted piece 22 constitutes a resilient lever possessing elastic force, which is flexed upward and downward with respect to the flat part 21 join portion as the basepoint.

When the tab terminal 4 described hereafter is inserted, this elastic force acts as an upward force that lifts the tab terminal 4. Also, a small boss 22b that projects from the surface is formed in the cut-and-lifted piece (resilient lever) 22. This small boss fits into a concavity in the tab terminal.

The pair of sideplate parts 23, 23 both have approximately the same height, and each has a cut-and-lifted tongue 24, 24 formed therein by cutting and lifting out a portion thereof of a particular size, from the top toward the bottom thereof. The sideplate parts 23, 23 are constituted of metal plate of a particular thickness and possess resilience thanks to having the cut-and-lifted tongues 24, 24 cut and lifted therefrom. For this reason, the cut-and-lifted tongues are termed “spring pieces” below.

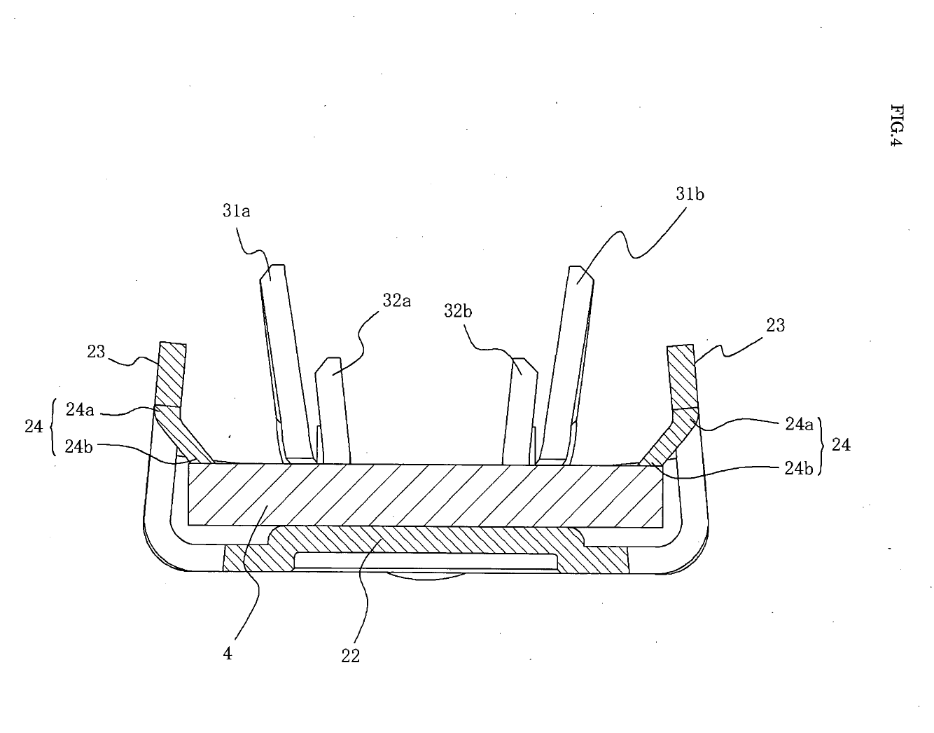

These spring pieces 24, 24 have the same shape. Accordingly, a single spring piece 24 is described below, with reference to FIGS. 1 and 4.

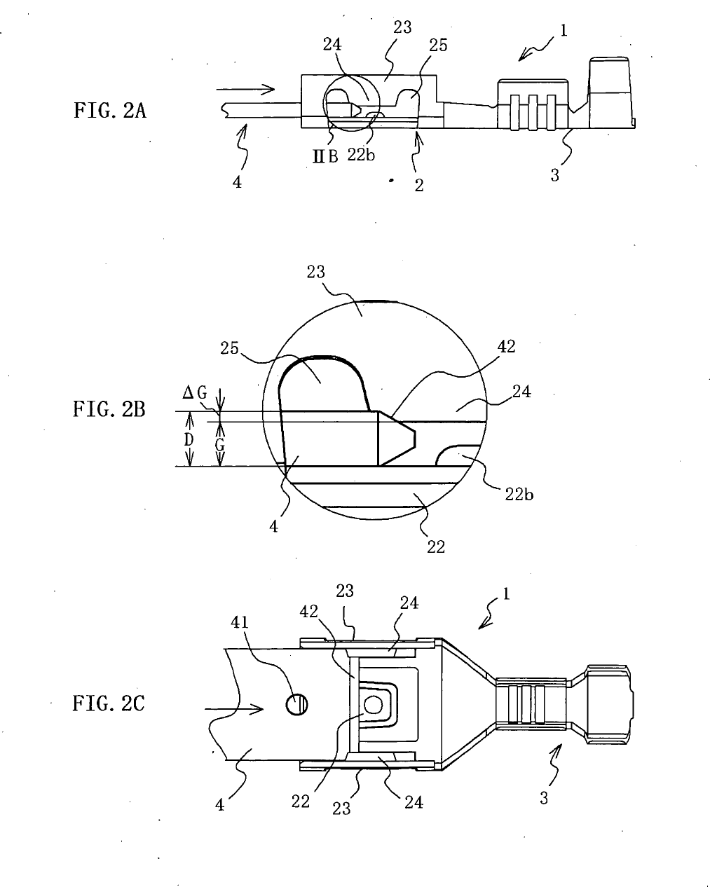

The spring piece 24 is approximately rectangular in shape, is joined at the upper edge 24a to the upper portion of the sideplate part 23, and has a cut-away slot 25 formed around the periphery, the lower edge 24b being a free extremity (see FIG. 4). From near the join with the sideplate part 23, the spring piece 24 is bent toward the other sideplate 23 that opposes that sideplate 23. As FIG. 2B shows, the spring piece 24 is of a length such that a gap G is formed between the free extremity 24b and the flat part 21. The gap G is determined so as to be narrower by, G than the thickness D of the tab terminal 4.

Next, the method of manufacturing the receptacle terminal 1 will be described. The receptacle terminal 1 is formed by punching and bend-processing metal plate.

First, a strip-shaped metal plate of good conductivity and having a particular width and length is punched to the size of the outspread receptacle terminal 1. During such punching, the slot 22a and cut-away slot 25 are formed. After such punching, the pair of sideplate parts 23, 23 are formed by bending from the flat part 21 so as to stand up in the same direction. Then the cut-and-lifted piece (resilient lever) 22 and cut-and-lifted tongues (spring pieces) 24, 24 are formed by bending. Such bendings may alternatively be performed at the time of the punching.

The receptacle terminal 1 thus manufactured is of a structure such that the tab terminal 4 described hereafter is supported between the lower sides 24b, 24b of the spring pieces 24, 24 provided in the sideplate parts 23, 23, and the flat part 21. Hence, the structure that supports the tab terminal 4 is essentially realized by the spring pieces 24, 24 provided in the sideplate parts 23, 23, so that the area of the metal plate of which the receptacle terminal 1 is constituted is rendered small compared with that of the related art. More precisely, it can be rendered small compared with an item of the related art having, for example, the contacting portion formed as a tubular body. Also, since the spring pieces 24, 24 are formed by cutting and lifting a portion of the sideplate parts 23, 23, the processing is simple. Thus, the receptacle terminal 1 of this embodiment has low material cost and moreover can be manufactured in a simple manner, enabling the costs to be drastically reduced. Further, although in the present embodiment a single spring piece is provided in each sideplate part, plural ones could alternatively be provided in each. Providing plural spring pieces would make it possible to vary the spring piece elastic force according to the number of spring pieces, enabling good connection when the tab terminal is inserted.

Also, as shown in FIG. 1 the tab terminal 4 is formed from metal plate with good conductivity, and has a contacting part 4a that is inserted into the receptacle terminal 1, and a terminal part 4b that extends from the contacting part 4a and is connected to a lead wire or the like. The contacting part 4a is of a width, length and thickness D such as to be inserted between the receptacle terminal 1's pair of sideplate parts 23, 23, and has, formed approximately in the center, a concavity 41 into which the receptacle terminal 1's small boss 22b engages. Also, the front end portion of the tab terminal 4 has inclined faces 42 processed in a taper shape.

The process of connecting the receptacle terminal 1 and the tab terminal 4 will next be described, with reference to FIGS. 1 to 4.

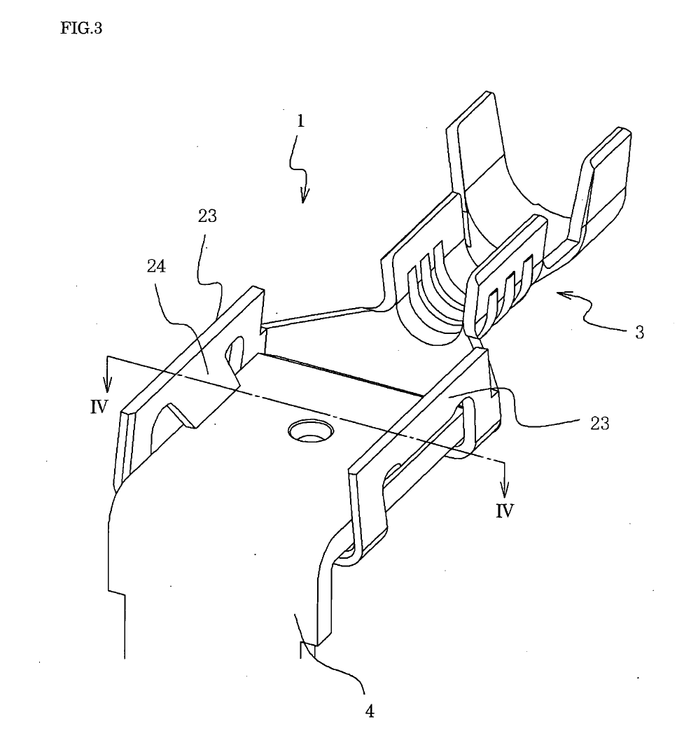

FIG. 1 shows the state prior to the tab terminal 4 being inserted into the receptacle terminal 1. When, from such state, the tab terminal 4 is slid in the direction indicated by the arrow in FIG. 1, the front end portion of the tab terminal 4 strikes against the edges of the spring pieces (cut-and-lifted tongues) 24, 24 provided in the sideplate parts of the receptacle terminal 1, as shown in FIG. 2. When pushed in further from such state, the tab terminal 4, guided by the inclined faces 42 formed at the front end portion thereof, enters into the gap G, pushing the lower edges 24b, 24b of the spring pieces 24, 24 upward, specifically by the amount, G. Such upward pushing takes place in opposition to the resilience of the spring pieces 24, 24, and therefore, as a result of the bias force generated by such upward pushing, the spring pieces 24, 24 are strongly pushed and contacted against the surfaces of the tab terminal 4. When the tab terminal 4 is pushed in further from such state, the concavity 41 in the tab terminal 4 engages with the small boss 22b and connection is complete, as shown in FIG. 3.

What is claimed is:

1. A receptacle terminal comprising:
a cable connection portion that is connected to a cable, and
a contacting portion that is insertion-connected to a tab terminal;
the contacting portion having a plate-form flat part of a particular area, and a pair of sideplate parts of a particular length that stand up in the same direction from the two sides of the flat part and oppose each other at a particular spacing; part of the lower portion of the opposed surfaces of such pair of sideplate parts being cut and lifted out to form a spring piece which remains joined to the sideplate at the top; such spring pieces being bent toward each other, forming a gap between the bottom edge of each spring piece and the flat part; and the tab terminal being inserted into such gaps.

2. The receptacle terminal according to claim 1, wherein one or plural spring pieces are provided on each sideplate part.

3. The receptacle terminal according to claim 1, wherein the spring pieces are formed in a rectangular shape.

4. The receptacle terminal according to claim 1, wherein the spring pieces are formed as resilient pieces that can be flexed, and the gaps are made smaller than the thickness of the tab terminal.

5. The receptacle terminal according to claim 1, wherein a resilient lever is formed in the flat part by cutting out and flexing upward a part thereof.

6. The receptacle terminal according to claim 5, wherein there is formed in the resilient lever a small boss that projects upward from the surface thereof.

7. The receptacle terminal according to claim 1, wherein the contacting portion and the cable connection portion are formed by punching and bend-processing of metal plate with good conductivity.
